(19) United States
(12) Patent Application Publication
(10) Pub. No.: US 2011/0225734 A1
(43) Pub. Date: Sep. 22, 2011

(54) Control System For Adjustment Apparatuses That Can Be Actuated By Way Of Electric Motors And Method For Generating Reliable Control Signals For Adjustment Apparatuses That Can Be Actuated By Way Of Electric Motors

(75) Inventors: Michael Hüppe, Gummersbach (DE); Michael Kritzler, Gummersbach (DE)

(73) Assignee: ILCON GMBH, Freudenberg (DE)

(21) Appl. No.: 13/050,181

(22) Filed: Mar. 17, 2011

(30) Foreign Application Priority Data
Mar. 18, 2010 (DE) 10 2010 011 938.5

(51) Int. Cl. A61G 7/018

(52) U.S. Cl. 5/616

(57) ABSTRACT

The invention relates to a control system for adjustment apparatuses that can be actuated by way of electric motors, which apparatuses are provided for beds, more particularly for hospital beds, nursing beds or the like, and also to a method for generating reliable control signals for adjustment apparatuses that can be actuated by way of electric motors, which apparatuses are provided for beds, more particularly for hospital beds, nursing beds or the like, with at least one control unit and at least one operating apparatus, comprising a manual switch for the patient, wherein the method comprises the monitoring and processing of output signals from the operating apparatus, and the generating of control signals in the control unit on the basis of output signals from the operating apparatus, wherein the monitoring and processing of the output signals is brought about at least in part by means of at least one processor in the control unit, and the method is distinguished by virtue of the fact that at least one control signal is additionally generated directly on the operating apparatus, which control signal, bypassing the processor, enables or blocks at least one adjustment apparatus.

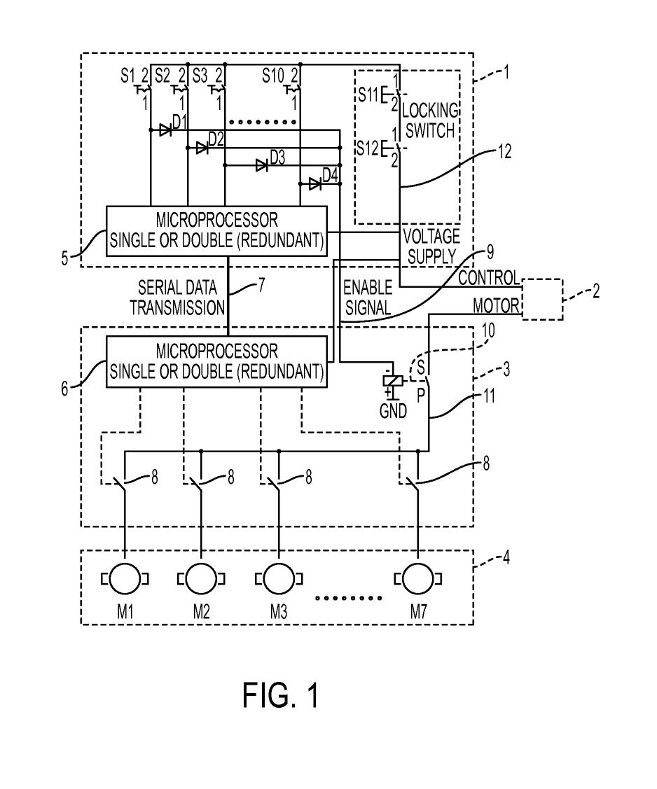

The invention relates to a control system for adjustment apparatuses that can be actuated by way of electric motors, which apparatuses are provided for beds, more particularly for hospital beds, nursing beds or the like, comprising at least one control unit, at least one current supply and at least one manual switch for the patient, which switch has actuation elements for generating control commands, wherein the manual switch for the patient is connected to the control unit via at least two signal lines and the control unit comprises at least one processor for generating switching commands for the purpose of actuating the adjustment apparatuses, wherein at least one signal line is provided for transmitting an enable signal from the manual switch for the patient to the control unit.

The invention furthermore relates to a method for generating reliable control signals for adjustment apparatuses that can be actuated by way of electric motors, which apparatuses are provided for beds, more particularly for hospital beds, nursing beds or the like, with at least one control unit and at least one operating apparatus, comprising a manual switch for the patient, wherein the method comprises the following steps:
monitoring and processing output signals from the operating apparatus,
generating control signals in the control unit on the basis of output signals from the operating apparatus, wherein the monitoring and processing of the output signals is brought about at least in part by means of at least one processor in the control unit.

A method for generating error-resilient control signals for an electric-motor furniture drive is known from e.g. DE 10 2007 054 422 A1. This document describes a method for generating initial reliable and error-resilient control signals, of at least one operating unit of an electric-motor drive for a piece of furniture with a control device and a safety device, wherein the method comprises the method steps of “monitoring and processing output signals from the operating unit by means of a central unit and generating initial error proof and error-free control signals on the basis of the processed output signals by means of the central unit”, wherein the monitoring and processing of the input signals occurs in parallel by at least two programmable controller apparatuses that monitor each other. The method furthermore comprises the generation of the actuation signals only after activation by means of a separate enable signal from an operating unit via a separate line for enabling the generation of actuation signals.

Particularly when used in beds in nursing and/or hospital settings, as well as in intensive care medicine, many different movement processes are, unlike in privately used bedroom furniture, usually controlled by different drives. Moreover, such apparatuses do not make all adjustment processes available to the patient in the bed. The movement processes of hospital beds can usually be controlled by means of a so-called manual switch for the patient, with the patient normally only being provided with a selection of a limited number of actuation functions.

As also described in DE 10 2007 054 422, specific switching functions of the manual switch for the patient can be enabled or blocked by the nursing staff.

In addition to the manual switch for the patient, there often are further actuation or operating apparatuses available, but these can only be reached by the nursing staff.

By way of example, patients in intensive care units should not be able to actuate adjustment apparatuses under any circumstances. It is also absolutely necessary in such apparatuses to ensure that there is no inadvertent actuation of the adjustment apparatus.

Thus, in the medical and nursing sector, the so-called initial error proof property of switching elements in the operating units plays a prominent role. By way of example, this initial error proof property is ensured by a certain mechanical switching reliability. Furthermore, there must be so-called error resilience, i.e. there may be no malfunctions as a result of operating errors or illogical actuation inputs.

In order to meet these requirements, DE 10 2007 054 422 proposes that, in particular, the monitoring and processing of the input signals from an operating unit is carried out in a control unit by means of two programmable controller apparatuses, i.e. two programmable microprocessors that monitor each other. This should ensure that all switching processes initiated by operating units are monitored, checked and transmitted in an initial error proof fashion by components that are not initial error proof, there being no transmission in the case of errors and/or risks being excluded.

Such a solution is particularly directed at the possibility of erroneous operation of operating units, but does not give due consideration to electronic failure or the generation of erroneous signals as a result of electrostatic discharge or the like. As an additional precautionary measure, DE 10 2007 054 422 proposes the provision of a separate signal line between an operating unit and a control device, with the enable signal generated by the operating unit being monitored and processed in a programmable control apparatus. This solution also only accounts for safety against erroneous operation, but does not provide sufficient safety against possible electronics malfunctions such as erroneous programming of the controller apparatuses as well.

DE 10 2005 031 820 B4 discloses a manual controller for electric-motor adjustment-drive devices for adjusting parts of furniture in the nursing or hospital sector, which controller has at least one drive motor and a control apparatus, wherein the manual controller has operating buttons for actuating a selected furniture part in a desired adjustment direction and a switch arrangement for blocking specific operating functions. The switching signal generated by the switch arrangement for blocking specific operating functions is transmitted to a control via a connection path in this arrangement as well, the adjustment motors of the piece of furniture being connected to said control. This arrangement does not take a malfunction of the control itself into account either.

The switch arrangement on the manual switch for the patient comprises an actuation element that is designed as a switchable dial, into which a transmission element in the form of a permanent magnet has been inserted in order to activate a reed contact in each case in specific positions. Such an arrangement is likewise prone to errors, particularly when fault currents are generated as a result of electrostatic discharges.

The invention is therefore based on the object of providing a control system of the type specified at the outset and a method for generating reliable control signals that are improved, particularly in respect of the generation of initial error proof control signals. More particularly, the above-described disadvantages should be corrected.

The object is firstly achieved by a control system for adjustment apparatuses that can be actuated by way of electric motors, which apparatuses are provided for furniture, more particularly for beds, more particularly for hospital beds, nursing beds or the like, comprising at least one control unit, at least one current supply and at least one manual switch for the patient, which switch has actuation elements for generating control commands, wherein the manual switch for the patient is connected to the control unit via at least two signal lines and the control unit comprises at least one processor for generating switching commands for the purpose of actuating the adjustment apparatuses, wherein one signal line is provided for transmitting an enable system from the manual switch for the patient to the control unit, wherein the control system according to the invention is distinguished by virtue of the fact that the signal line for transmitting the enable signal is directly, i.e. bypassing a controller apparatus and/or a processor/microprocessor, connected to a switching apparatus for actuating at least one adjustment apparatus.

By way of example, a separate relay in a control or in a mains disconnection means can be activated by such a signal line. It is not possible to drive an adjustment apparatus or a drive without this signal, regardless of which signals from the processor or the controller apparatus are present.

The signal line for transmitting the enable signal is preferably directly connected to a switching apparatus for disconnecting at least one adjustment apparatus, preferably all adjustment apparatuses, from the voltage supply.

Provision is made for the adjustment apparatuses to be disconnected from the mains or the voltage supply when the switching apparatus is not being actuated, and for an enable signal to be generated simultaneously with the relevant button command for adjusting a specific fitting component on the piece of furniture, which enable signal enables one or more adjustment apparatuses.

The manual switch for the patient expediently comprises at least one switch arrangement for blocking specific operating functions.

By way of example, the switch arrangement for blocking operating functions may comprise an actuation element that can be locked by mechanical means.

As an alternative to the generation of the enable signal by an actuation element on a manual switch for the patient, the enable signal can also be able to be generated in an additional operating unit that can only be reached by the nursing staff.

In a preferred variant of the control system according to the invention, provision is made for the actuation element to bring about the switching function in a direct mechanical fashion. This gives particular consideration to the requirement of error resilience.

In a further preferred variant of the control system according to the invention, provision is made for an operation of at least one actuation element, or of each actuation element, for example in the form of a button on the manual switch for the patient or on a further operating apparatus, to cause the transmission of an enable signal at the same time as a control command.

The enable signal is expediently transmitted over a separate signal line.

Additionally, a locking switch is able to lock all buttons or groups of buttons and/or all actuation elements or groups of actuation elements. By way of example, a locking switch may comprise three switch positions with respectively two buttons in series.

The object on which the invention is based is furthermore achieved by a method for generating reliable control signals for adjustment apparatuses that can be actuated by way of electric motors, which apparatuses are provided for beds, more particularly for hospital beds, nursing beds or the like, with at least one control unit and at least one operating apparatus, wherein the operating apparatus comprises at least one manual switch for the patient, wherein the method comprises the following steps:
monitoring and processing output signals from the operating apparatus,
generating control signals in the control unit on the basis of output signals from the operating apparatus, wherein the monitoring and processing of the output signals is brought about at least in part by means of at least one processor in the control unit, wherein the method is distinguished by virtue of the fact that at least one control signal is additionally generated directly on the operating apparatus, which control signal, bypassing the processor, enables or blocks at least one adjustment apparatus.

The invention is based on the discovery that the use of processors, more particularly microprocessors, which are indispensible for functions such as synchronous operation, sequencing or soft control, fundamentally harbors certain safety risks, particularly in respect of how reliable the signals are.

It is for this reason that at least one control signal is additionally generated directly in the operating apparatus, for example in the manual switch for the patient, which control signal, bypassing the processor, actuates a switching apparatus for an adjustment apparatus, for example an electric motor drive.

A preferred variant of the method is distinguished by virtue of the fact that a mains disconnection of at least one adjustment apparatus is actuated directly via the additional control signal.

By way of example, the additional control signal can be used as an enable signal for disconnecting at least one adjustment apparatus from the mains. Within the scope of the invention, an enable signal means that the adjustment apparatus and/or at least one drive is, as a matter of principle, disconnected from the mains or the voltage supply when not actuated, and so the generation of an additional enable signal, i.e. for applying voltage to the adjustment apparatus, is required in any case.

Both the manual switch for the patient and another operating unit, and also the control unit as per the invention, can comprise one microprocessor or a number of redundant microprocessors that respectively monitor one another.

An example of a control system according to the invention will be explained below on the basis of an attached schematic circuit diagram. The control system according to the invention comprises at least one manual switch 1 (manual switch for the patient), a voltage source 2 and a control unit 3, which act on drives 4 of unset adjustment apparatuses on a piece of furniture, for example on a hospital bed.

The manual switch 1, the voltage source 2, the control unit 3 and the drives 4 are interconnected in a conventional fashion by means of cables. The control system according to the invention can comprise one or more operating units (not illustrated).

The manual switch 1, which can be conventionally embodied as a hand-piece with a membrane keypad, comprises a plurality of push-button switches S1 to S10, and two locking switches S11 and S12, with each push-button switch S1 to S10 being associated with an actuation element for adjusting a movable part of a piece of furniture. It should be mentioned here that the drives 4 are each associated with actuators acting on specific fitting elements of the furniture (adjustment apparatus).

The locking switches S11 and S12 are connected in series and, in the opened state, interrupt the voltage supply 12 of both a first microprocessor 5 arranged in the manual switch 1 and a second microprocessor 6 arranged in the control unit 3. The first microprocessor 5 and the second microprocessor 6 are interconnected by a serial data line 7. The push-button switches S1 to S10 generate control signals in the manual switch 1 with the aid of the first microprocessor 5, which manual switch is an operating apparatus, which control signals are monitored and evaluated by the second microprocessor 6 in the control unit 3 and are transmitted on to the switches 8 associated with the drives 4 in switching commands. Parallel to the serial data line 7, provision is made for a second signal line 9 between the manual switch 1 and the control unit 3, via which second signal line a parallel enable signal is respectively generated in a relay 10 when one of the push-button switches S1 to S10 is actuated. The relay 10 is open when none of the push-button switches S1 to S10 are actuated; when the latter are actuated, a voltage supply 11 from the voltage source 2 to the drives 4 is closed.

When one of the push-button switches S1 to S10 is actuated, an output signal with a corresponding switching command is always transmitted from the first microprocessor 5 to the second microprocessor 6 in the control unit 3 via the serial data line 7. Parallel thereto, an enable signal is generated via the second signal line 9, which enable signal enables the voltage supply 11 from the voltage source 2 to the switches 8 via the relay 10, and so an actuation of said switches via the second microprocessor 6 for the purpose of actuating the drives 4 or the adjustment apparatuses is possible.

The locking switches S11 and S12 can interrupt the voltage supply 12 to the push-button switches S1-S10. This is usually brought about by a key for the nursing staff, which key is specifically designed for actuating the locking switches S11 and S12. When the locking switches S11 and S12 are open, one or more push-button switches can be blocked in groups. In the schematically illustrated exemplary embodiment, all push-button switches S1 to S10 are illustrated as locked. The number of push-button switches S1-S10 and the number of locking switches S11 and S12 are not critical to the invention. The locking switch S11-S12 is embodied as a redundant switch arrangement.

### LIST OF REFERENCE SIGNS

1 Manual switch
2 voltage source
3 Control unit
4 Drives
S1-S10 Push-button switches
S11, S12 Locking switches
5 First microprocessor
6 Second microprocessor
7 Serial data line
8 Switch
9 Second signal line
10 Relay
11 voltage supply
12 voltage supply

1. Control system for adjustment apparatuses that can be actuated by way of electric motors, which apparatuses are provided for beds, more particularly for hospital beds, nursing beds or the like, comprising at least one control unit, at least one current supply and at least one manual switch for the patient, which switch has actuation elements for generating control commands, wherein the manual switch for the patient is connected to the control unit via at least two signal lines and the control unit comprises at least one processor for generating switching commands for the purpose of actuating the adjustment apparatuses, wherein one signal line is provided for transmitting an enable signal from the manual switch for the patient to the control unit, characterized in that the signal line for transmitting the enable signal is directly connected to a switching apparatus for actuating at least one adjustment apparatus.

2. Control system according to claim 1, characterized in that the signal line for transmitting the enable signal is directly connected to a switching apparatus for disconnecting at least one adjustment apparatus, preferably all adjustment apparatuses, from the voltage supply.

3. Control system according to claim 1, characterized in that the manual switch for the patient has at least one switch arrangement for blocking specific operating functions.

4. Control system according to claim 3, characterized in that the switch arrangement for blocking locking functions comprises an actuation element that can be locked by mechanical means.

5. Control system according to claim 4, characterized in that the actuation element brings about the switching function in a direct mechanical fashion.

6. Control system according to claim 1 , characterized in that an operation of at least one actuation element, preferably each actuation element, causes the transmission of an enable signal at the same time as a control command.

7. Method for generating reliable control signals for adjustment apparatuses that can be actuated by way of electric motors, which apparatuses are provided for beds, more particularly for hospital beds, nursing beds or the like, with at least one control unit and at least one operating apparatus, wherein the operating apparatus comprises at least one manual switch for the patient, wherein the method comprises the following steps:
monitoring and processing output signals from the operating apparatus,
generating control signals in the control unit on the basis of output signals from the operating apparatus, wherein the monitoring and processing of the output signals is brought about at least in part by means of at least one processor in the control unit, characterized in that at least one control signal is additionally generated directly on the operating apparatus, which control signal, bypassing the processor, enables or blocks at least one adjustment apparatus.

8. Method according to claim 7, characterized by directly actuating a mains disconnection of at least one adjustment apparatus via the additional control signal.

9. Method according to claim 7, characterized in that the additional signal is used as an enable signal for disconnecting at least one adjustment apparatus from the mains.

10. Method according to claim 7, characterized in that at least one control signal is generated directly at the same time as each output signal from the operating apparatus, which at least one control signal enables or blocks the voltage supply of at least one adjustment apparatus, preferably of all adjustment apparatuses.
